(19) United States
(12) Patent Application Publication
(10) Pub. No.: US 2008/0157555 A1
(43) Pub. Date: Jul. 3, 2008

(54) LOCKING MECHANISM FOR RETRACTABLE CARGO BED

(75) Inventors: Jeffrey H. Steele, Edmonton (CA); John Gladwin, Edmonton (CA); Erich Janke, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: CARGO BED LICENSING INC., Edmonton (CA)

(21) Appl. No.: 11/773,369

(22) Filed: Jul. 3, 2007

(30) Foreign Application Priority Data
Jan. 3, 2007 (CA) 2,573,256

(51) Int. Cl. B62D 33/08; B60P 1/00

(52) U.S. Cl. 296/26.09

(57) ABSTRACT

A locking mechanism for a retractable cargo bed includes an engagement rail forming part of a stationary frame; the engagement rail having a top edge profile defining a plurality of locking recesses. A locking member carried by a travelling frame and adapted to engage a selected locking recess of the plurality of locking recesses. A spring adapted to bias the locking member into engagement with the selected locking recess. An activation lever adapted to permit a user to overcome the biasing force of the spring to disengage the locking member from the selected locking recess.

### FIELD

The present invention relates to a locking mechanism that prevents a retractable cargo bed from uncontrolled movement sliding movement when positioned on an incline.

### BACKGROUND

U.S. Pat. No. 6,659,524 (Carlson) discloses a retractable cargo bed with a locking mechanism to control sliding movement of the cargo bed when positioned on an incline.

### SUMMARY

There is provided a locking mechanism for a retractable cargo bed which includes an engagement rail forming part of a stationary frame; the engagement rail having a top edge profile defining a plurality of locking recesses. A locking member carried by a travelling frame and adapted to engage a selected locking recess of the plurality of rectangular locking recesses. A spring adapted to bias the locking member into engagement with the selected locking recess. An activation lever adapted to permit a user to overcome the biasing force of the spring to disengage the locking member from the selected locking recess.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a top plan view of a retractable cargo bed with a locking mechanism.

FIG. 2 is a top plan view of a stationary frame for the locking mechanism for a retractable cargo bed illustrated in FIG. 1.

FIG. 3 is a top plan view of a travelling frame for the locking mechanism for a retractable cargo bed illustrated in FIG. 1.

FIG. 4 is a side elevation view of the engagement rail for the locking mechanism for a retractable cargo bed illustrated in FIG. 1.

FIG. 5 is a detailed end elevation view, in section, of the locking mechanism for a retractable cargo bed illustrated in FIG. 1, showing spring detail.

FIG. 6 is a detailed end elevation view, in section, of the locking mechanism for a retractable cargo bed illustrated in FIG. 1, showing locking member detail.

### DETAILED DESCRIPTION

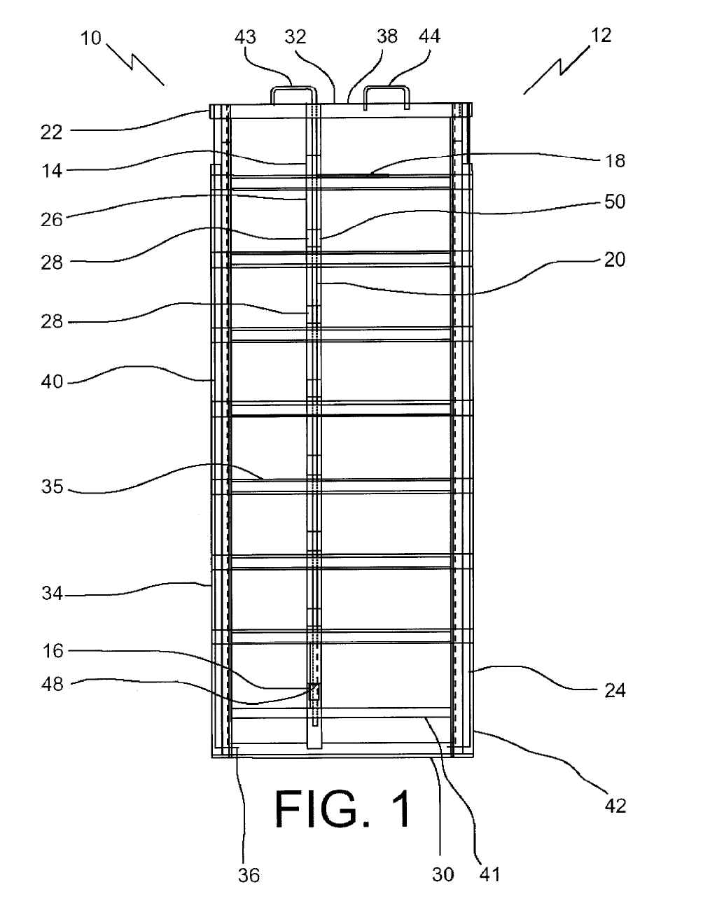

A locking mechanism for a retractable cargo bed generally identified by reference numeral 10, will now be described with reference to FIG. 1 through 6.

Structure and Relationship of Parts:

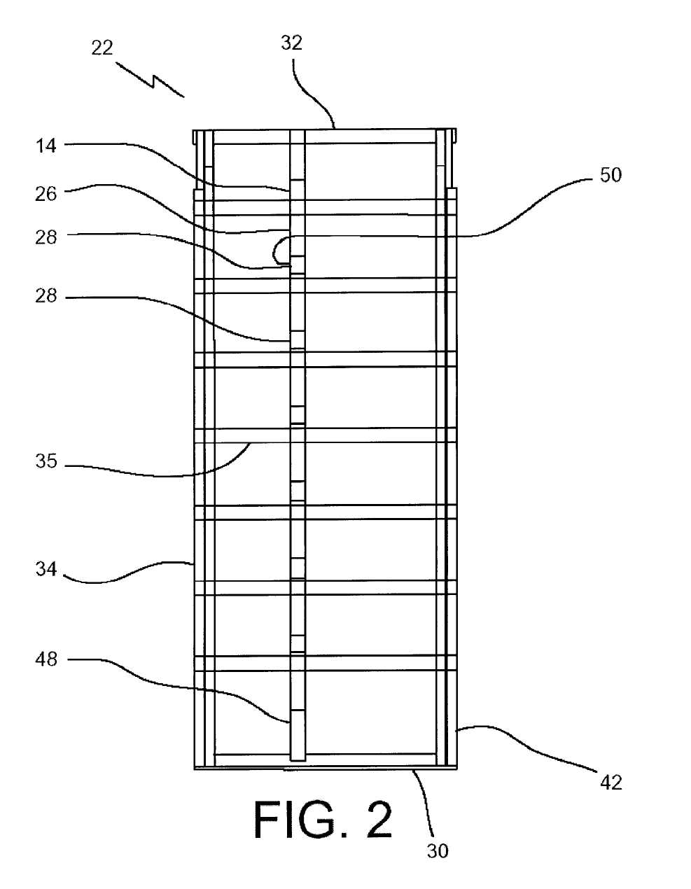

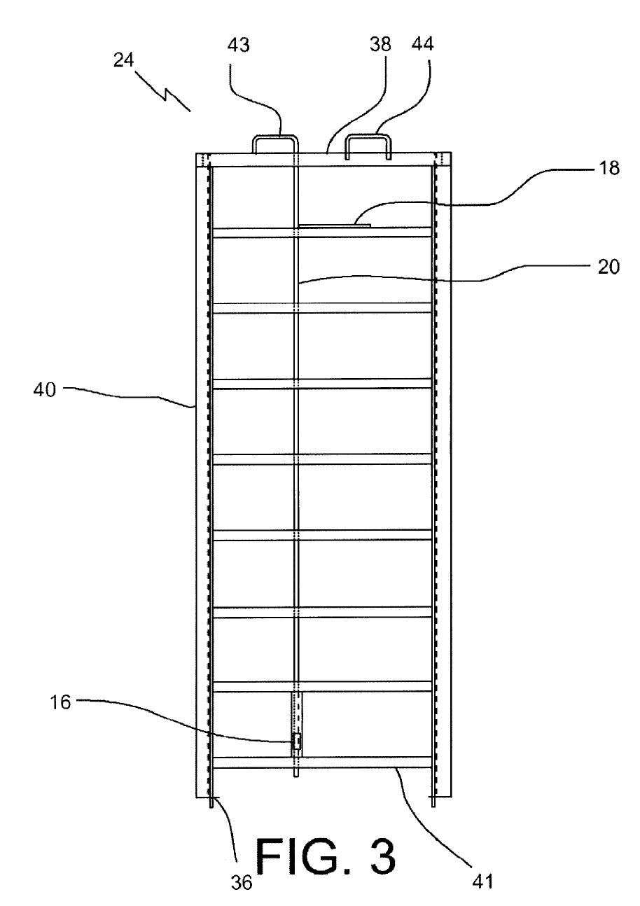

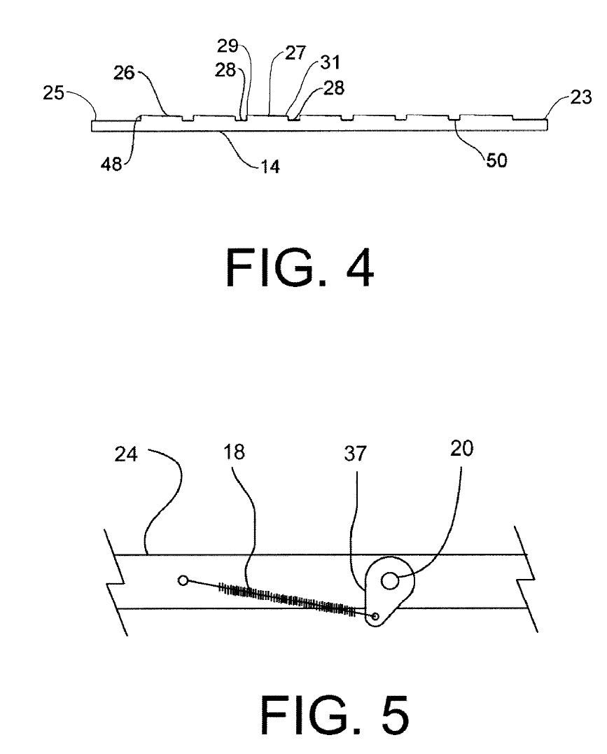

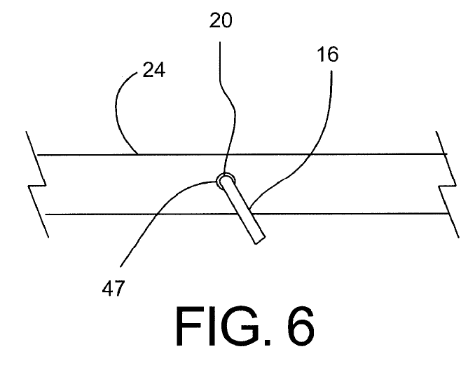

Locking mechanism 10 for a retractable cargo bed 12 is illustrated in FIG. 1. Cargo bed 12 may be located in the back of a vehicle (not shown) or truck. Locking mechanism 10 has an engagement rail 14, a locking member 16, a spring 18, and an activation lever 20. Cargo bed 12 consists of a stationary frame 22 illustrated in FIG. 2 and a travelling frame 24 illustrated in FIG. 3. Referring to FIG. 2, engagement rail 14 forms part of stationary frame 22. Referring to FIG. 4, engagement rail 14 has first end 23, a second end, 25 and a top edge profile 26 defining a plurality of fins 27 separated by locking recesses 28. As will hereinafter be further described, positioning engagement rail 14 such that locking recesses 28 are upward helps avoid skipping by having gravity assist locking member 16 to engage locking recesses 28. Each fin 27 has a first end 29 and a second end 31. Top edge profile 26 between each of locking recesses 28, or in other words each fin 27, is preferably sloped toward second end 31. This means the first end 29 of each fin 27 is higher than second end 31 of a preceding fin. This helps prevent locking member 16 from skipping over recess 28 when moving from first end 23 of engagement rail 14 toward second end 25 of engagement rail 14, as locking member 16 exiting second end 31 of a preceding fin 27 will strike first end 29 of the next fin and be unable to travel further. Upon striking first end 29 of fin 27, locking member 16 will drop into locking recess 28 urged by gravity and a biasing force supplied by spring 18, as will hereinafter be further described. Engagement rail 14 is stamped out of a single piece of plate steel. Referring to FIG. 3, locking member 16, spring 18 and activation lever 20 are all carried by travelling frame 24. Engagement rail 14, locking member 16 and activation lever 20 may all be positioned off-center, as shown in FIG. 1. As will hereinafter be further described, spring 18 is provided to bias locking member 16 into engagement with a selected one of locking recesses 28. Referring to FIG. 2, stationary frame 22 has a first end 30, a second end 32, guides 34, and lateral supports 35. In the embodiment detailed in the figure, engagement rail 14 is carried overtop of lateral supports 35. Referring to FIG. 3, travelling frame 24 has a first end 36, a second end 38, sides 40, and lateral supports 41. In the embodiment shown in the figure, activation lever 20 is carried through lateral supports 41. FIG. 6 shows activation lever 20 positioned within guide holes 47, guide holes 47 being located through lateral supports 41 of travelling frame 24. Guides 34 may consist of a rail system 42 with or without wheels (not shown) designed to allow travelling frame 24 to slide overtop of stationary frame 22. This could be accomplished by containing sides 40 of travelling frame 24 within guides 34, in such a way that travelling frame 24 is able to extend and retract overtop of stationary frame 22. Referring to FIG. 1, spring 18 is attached to activation lever 20 in the vicinity of handle 43. Referring to FIG. 5, spring 18 is attached to travelling frame 24 and extends to activation lever 20. FIG. 1 shows cargo bed 12 in a retracted position. In the embodiment shown in this figure, first end 30 of stationary frame 22 is oriented below first end 36 of travelling frame 24. In addition, second end 32 of stationary frame 22 is oriented below second end 38 of travelling frame 24. Activation lever 20 is connected to locking member 16, activation lever 20 also having a handle 43 at second end 38 of travelling frame 24. There is also may be a second handle 44 positioned at second end 38 of travelling frame 24, as shown in FIG. 1.

FIG. 6 shows locking member 16 in the locked position, angled downward to engage of engagement rail 14 of FIG. 4. Referring to FIG. 6, when locking member 16 is in the release position, it is turned to a substantially horizontal release position (not shown). Locking member 16 is adapted to engage a selected one of locking recesses 28, shown in FIG. 1 and FIG. 4. Spring 18 provides a biasing force on activation lever 20, as shown in FIG. 5. This biasing force is transmitted to activation lever 20 through attachment lever 37. Activation lever 20 is adapted to permit a user to overcome the biasing force of spring 18 (by exerting a force upon handle 43) to disengage locking member 16 from the selected one of locking recesses 28 that locking member 16 is engaged to, as shown in FIG. 1. FIG. 5 shows activation lever 20 being turned against the biasing force of spring 18, in order to unlock locking member 16 (not shown). When no force is applied to activation lever 20 (through handle 43) to overcome the biasing force of spring 18, the biasing force rotates activation lever 20 into a locking position with engagement rail 14.

Operation:

When cargo bed 12 is in the retracted position as shown in FIG. 1, spring 18 biases locking member 16 into a locking position with engagement rail 14. Locking member 16 is engaged by a first recess 48 of locking recesses 28. In this position, travelling frame 24 is unable to slide overtop of stationary frame 22. Lateral supports 35 and 41 of stationary and travelling frames 22 and 24, respectively, prevent their respective frames (22 or 24) from bending during the extension/retraction of cargo bed 12. Lateral supports 35 and 41 also provide a surface for transporting weight. In order to extend cargo bed 12, locking mechanism 10 must be unlocked. Locking mechanism 10 is unlocked by turning handle 43 against the biasing force of spring 18 to move locking member 16 into a substantially horizontal position. This disengages locking member 16 from contact with engagement rail 14, and allows travelling frame 24 to freely slide overtop of stationary frame 22. During either extension or retraction of travelling frame 24, locking member 16 must be disengaged from engagement rail 14. This is accomplished by maintaining handle 43 in the unlocked position, against the force of spring 18. Second handle 44 assists this manoeuvre, as a user is able to grip second handle 44 in one hand and handle 43 in the other. That way a user can extend/retract cargo bed 12 while keeping locking mechanism 10 unlocked. Cargo bed 12 can be locked in the extended position (not shown) by allowing spring 18 to bias locking member 16 back into engagement with engagement rail 14. There may be stops (not shown) positioned on one or both of travelling and stationary frames 24, 22, stops designed to restrict the range of movement of travelling frame 24 overtop of stationary frame 22. These stops would be useful in preventing locking member 16 from extending past a last recess 50 of locking recesses 28 of stationary frame 22 during the extension of cargo bed 12.

Advantages:

The locking mechanism described above provides the following advantages over the locking mechanism of the original Carlson patent:

### Major Improvements:

1. Safety—The original Carlson patent had a series of triangular pieces welded onto a rail. The triangular pieces served as a ratchet when the cargo bed was being pushed in, providing a series of intermediate stages for the locking member. When the cargo bed was being moved out, the triangular pieces provided positive stops to control outward movement. The configuration with square recesses of the present locking mechanism provides positive stops which lock in either direction. It was found that if there was a steep enough incline the ratchet did not work as intended and there tended to be uncontrolled inward movement of the cargo bed.
2. Cost of Manufacture—The original Carlson patent was fabricated by welding triangular pieces to a rail. The welding and subsequent grinding to remove surface imperfections was labour intensive. The stamping of the rail profile out of a single piece of sheet steel and then bending to provide better engagement has proven to be a much more cost effective manner of manufacturing the locking rail.

### Minor Improvements

3. Spring Access—The original Carlson patent positioned the spring remote from the handle. This required disassembly in order to check the condition of the spring or replace the spring. The spring is now positioned adjacent the handle where is can readily be inspected and, if necessary, replaced.
4. Twin Handles—The original Carlson patent had a handle at one end of the travelling frame and a separate activation lever. There are now two handles, one of which actives the lever. This enables the cargo bed to be held with one handle, while the lever is activated using the other handle.
5. Handle Size—The handles have been made larger, so that they can be more readily used by persons wearing large work gloves, such as welder's gloves.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A locking mechanism for a retractable cargo bed, comprising
an engagement rail forming part of a stationary frame, the engagement rail having a top edge profile defining a plurality of locking recesses;
a locking member carried by a travelling frame and adapted to engage a selected locking recess of the plurality of locking recesses;
a spring adapted to bias the locking member into engagement with the selected locking recess; and
an activation lever adapted to permit a user to overcome the biasing force of the spring to disengage the locking member from the selected locking recess.

2. The locking mechanism of claim 1, wherein the engagement rail is stamped out of a single piece of plate steel.

3. The locking mechanism of claim 1, wherein the engagement rail has a first end and a second end, and the top edge profile defining a plurality of fins positioned between each of the locking recesses, the fins being is sloped downwardly toward the second end of the engagement rail.

4. The locking mechanism of claim 1, wherein the activation lever has a handle positioned at one end of the travelling frame.

5. The locking mechanism of claim 4, wherein there are two handles at the one end of the travelling frame, one of which serves as the activation lever.

6. The locking mechanism of claim 4, wherein the spring is attached to the activation lever in the vicinity of the handle.
